(19) United States
(12) Patent Application Publication
(10) Pub. No.: US 2007/0201737 A1
(43) Pub. Date: Aug. 30, 2007

(54) System And Method For Vascular Visualization Using Planar Reformation Of Vascular Central Axis Surface With Biconvex Slab

(76) Inventor: Wenli Cai, Dorchester, MA (US)

Correspondence Address: F. CHAU & ASSOCIATES, LLC, 130 WOODBURY ROAD, WOODBURY, NY, 11797, US

(21) Appl. No.: 10/580,774

(22) PCT Filed: Nov. 24, 2004
(86) PCT No.: PCT/US04/39896

§ 371 Date: May 7, 2007

Related U.S. Application Data
(60) Provisional application No. 60/525,603, filed on Nov. 26, 2003.

(51) Int. Cl. G06K 9/00

(52) U.S. Cl. 382/131

(57) ABSTRACT

A method for visualizing a vascular structure includes obtaining an image dataset (step 20), selecting a vascular central axis (VCA) and a vector of interest (VOI) (step 21), forming a plurality of cross sections perpendicular to the vascular central axis, forming a convex hull to enclose each cross section (step 22), wherein the convex hull is oriented by the vector of interest and determined by the shape of the cross section, and connecting each convex hull to form a biconvex slab (step 23). The biconvex slab comprises two curved surfaces that enclose a 3D volume including the vascular structure 21 of interest. The volume within the biconvex slab can rendered to obtain a 3D view of the entire vascular structure (step 24). Since the biconvex slab is a 3D volume, volume rendering techniques can be used to render the 3D information and generate a resulting image of the vascular structure in a flattened plane having precise 3D spatial information.

### CROSS REFERENCE TO RELATED APPLICATION

This application claims priority to U.S. Provisional Application Ser. No. 60/525,603, filed on Nov. 26, 2003, the contents of which are incorporated herein by reference.

### TECHNICAL FIELD OF THE INVENTION

The present invention relates generally to systems and methods for vascular visualization, and in particular, systems and methods for 3-D visualization of vascular structures using VCAS (vascular central axis surface) planar reformation (or VPR) rendering of 3D biconvex slab volumes.

### BACKGROUND

Digital images are created from an array of numerical values representing a property (such as a grey scale value or magnetic field strength) associable with an anatomical location points referenced by a particular array location. The set of anatomical location points comprises the domain of the image. In 2-D digital images, or slice sections, the discrete array locations are termed pixels. Three-dimensional digital images can be constructed from stacked slice sections through various construction techniques known in the art. The 3-D images are made up of discrete volume elements, also referred to as voxels, composed of pixels from the 2-D images. The pixel or voxel properties can be processed to ascertain various properties about the anatomy of a patient associated with such pixels or voxels.

Various image reconstruction and visualization techniques have been widely used in Computerized Tomographic Angiography (CTA) to supplement the original axial images including, for example, MPR (multi planar reconstruction), MIP (maximum intensity projection); shaded-surface display; and volume rendering. Although volume rendering is an accurate method for evaluating all grades of stenosis, in general these methods are inadequate to visualize vascular structures. For instance, the entire vessel cannot be visualized in one image, including its lumen, wall, and surroundings.

One way to visualize a vascular structure is to resample and visualize the vascular central axis surface (VCAS), a curved surface passing through the vascular central axis (VCA) or vessel centerline. This process is variously referred to as curved Multi Planar Reformation (curved MPR), Curved Planar Reformation (CPR), and Medial Axis Reformation (MAR). In the context of vascular visualization these terms are not precise enough to describe the fact that the VCA is located on this curved surface. For this reason, the acronym VCAS is used herein to identify a curved cross-section that passes through the entire VCA, and the term planar reformation refers to the process to flatten the VCAS. By this technique, VCAS planar reformation (VPR), the entire vessel can be flattened on a planar surface and the whole vascular centerline can be displayed on a single image.

In general, VPR techniques allow the investigation of the vessel lumen in a longitudinal cross-section through the VCA. However, vascular abnormalities, such as stenosis and calcium, might not be scanned by this surface and therefore they do not appear in the generated image. One way to overcome this problem is to rotate the VCAS along the longitudinal axis, which results in a set of 2D images. These 2D images can be used to diagnose calcification and stenosis as well as other vascular diseases, in the same way as viewing 2D CTA slices can be used to understand the 3D relationships and positions of objects. However, there is no 3D information on the images.

VCA extraction is the basic procedure for vascular analysis. There exist a wide variety of VCA extraction algorithms. Based on the input data they can be categorized into two groups: those using segmentation data, or those using raw data. Segmentation data group methods include the maximum inscribed sphere method, 3D thinning algorithms based on the grass-fire definition, a minimum-cost path using Dijkstra's shortest path searching algorithm, and methods using inner Voronoi diagrams. Raw data based methods, which are sometimes referred to as direct tracking methods, include Dijkstra's shortest path algorithm, wave propagation tracking, and the intensity ridge method. In general, VCA extraction algorithms can find the vessel centerline and some other corresponding geometric information, such as maximum and minimum diameters, contours, area, etc. at each point of the centerline.

Traditional curved MPR forms a 2D image, and lacks the 3D information of the entire vessel. To create a 3D VPR, one needs a slab, i.e. a thick VCAS. One can create a thin slab by sweeping the VCAS along the view direction. However, a thin slab has some disadvantages for rendering VPR. First, a vessel is a thin object and is often located near other organs. A thin slab can include other adjacent organs. When the vessel has varying diameters, the thickness of the thin slab is difficult to control. In addition, there are frequently obstructions that hide the views of the vascular lumen. Second, the vessel centerline is often very long, resulting in a very long slab after stretching. Thus, rendering a very long slab can become a time consuming task.

Research on VPR has focused on two points: (1) how to visualize entire vascular lumen and wall in one image; and (2) how to visualize the entire vessel tree in one image. Ideally one would like to render the entire vascular lumen in one image. One method involves using a helical scan line starting from center point to scan the vascular lumen instead of the straight scan line. The resulting image of helical CPR rolls out the vascular lumen. This image can visualize stenosis and calcification more clearly than normal curved MPR, but it is difficult to understand the 3D information from a helical CPR, such as the correct position and orientation of calcium and stenosis. This difficulty is caused by the 2D image of CPR. Other methods suffer from the ability to help a radiologist to find vascular abnormalities efficiently.

### SUMMARY OF THE INVENTION

Exemplary embodiments of the invention as described herein generally include systems and methods for vascular visualization using VPR (VCAS (vascular central axis surface) planar reformation) rendering techniques. More specifically, exemplary embodiments of the invention include systems and method for 3-D visualization of vascular structures using VPR rendering of 3D biconvex slab volumes to enable visualization of precise 3D spatial information of an entire vascular volume in one VPR image. Exemplary methods for vascular visualization using VPR rendering according to the invention provide efficient real-time processing of digital image data of vascular structures to accurately present calcification and stenosis.

In accordance with the invention, there is provided a method of visualizing a vascular structure, the method comprising the steps of providing a digital image of a vascular structure wherein the image comprises a plurality of intensities corresponding to a domain of points in a D-dimensional space, selecting a vascular central axis and a vector of interest in the image of the vascular structure, and forming a plurality of cross sections perpendicular to the vascular central axis, forming a convex hull to enclose each cross section, wherein the convex hull is oriented by the vector of interest and determined by the shape of the cross section, connecting each convex hull to form a biconvex slab, and rendering the biconvex slab to form an image of the vascular structure.

In a further aspect of the invention, the rendering further comprises the steps of defining a viewing vector perpendicular to a plane containing the vector of interest and the vascular central axis, forming a scan line through the vascular structure and along the vector of interest, wherein the scan line includes a left point, a center point, and a right point, forming a square bounding box about the convex hull, wherein the intersection of each scan line with the bounding box defines a rendering range, and emitting a ray through each pixel within the rendering range, wherein the rendering depth of the ray is within the maximum radius of the hull.

In a further aspect of the invention, the rendering further comprises the steps of estimating a ray that passes through the image, wherein the ray estimation is determined by the bounding box, calculating an entry point and an exit point of the ray through the vascular structure in the image, including a margin on each side of the bounding box, and repeating the estimating step and calculating step to accumulate each volume contribution.

In a further aspect of the invention, the rendering further the steps of forming a contour from each the cross section, projecting the contour along the viewing vector to the scan line to find a maximum forward depth and a maximum backward depth along the scan line, including a margin on each side of the bounding box, and repeating the projecting step to accumulate each volume contribution.

In a further aspect of the invention, the rendering further comprises a curved multi-planar reformation of the biconvex slab with rotation.

In a further aspect of the invention, the curved multi-planar reformation includes a modified maximum intensity projection.

In a further aspect of the invention, the curved multi-planar reformation includes a modified x-ray projection.

In a further aspect of the invention, the curved multi-planar reformation includes an adjustable diameter slab maximum intensity projection.

In a further aspect of the invention, the rendering further comprises a luminal multi-planar reformation on the biconvex slab with rotation.

In a further aspect of the invention, the rendering further comprises a luminal curved-planar reformation on the biconvex slab with rotation.

In a further aspect of the invention, the method further comprises displaying in three-dimensional a double-oblique cross-sectional slab location.

In a further aspect of the invention, the method further comprises the step of interactively rotating the image of the vascular structure in order to determine a viewing vector.

In a further aspect of the invention, the method further comprises the step of interactively zooming-in or zooming-out the image of the vascular structure.

In another aspect of the invention, there is provided a program storage device readable by a computer, tangibly embodying a program of instructions executable by the computer to perform the method steps for visualizing a vascular structure.

These and other exemplary embodiments, features, aspects, and advantages of the present invention will be described and become more apparent from the detailed description of exemplary embodiments when read in conjunction with accompanying drawings.

### BRIEF DESCRIPTION OF THE DRAWINGS

FIG. 1A is a diagram that schematically illustrates a conventional method for VPR rendering.

FIG. 1B is a diagram that schematically illustrates a method for VPR rendering using a thick 3D biconvex slab according to an exemplary embodiment of the invention.

FIG. 2 is a flow diagram illustrating a method for vascular visualization according to an exemplary embodiment of the invention.

FIG. 3 is a diagram that schematically illustrates a method for constructing a 3D biconvex slab for VPR rendering according to an exemplary embodiment of the invention.

FIGS. 4A and 4B are schematic diagrams that illustrate a method for constructing a biconvex slab according to another exemplary embodiment of the invention, wherein the image space of the biconvex slab is assumed to be a square bounding box.

FIGS. 5A and 5B are schematic diagrams that illustrate methods for minimizing the image space of the exemplary biconvex slab of FIGS. 4A and 4B for volume rendering, according to exemplary embodiments of the invention.

### DETAILED DESCRIPTION OF EXEMPLARY EMBODIMENTS

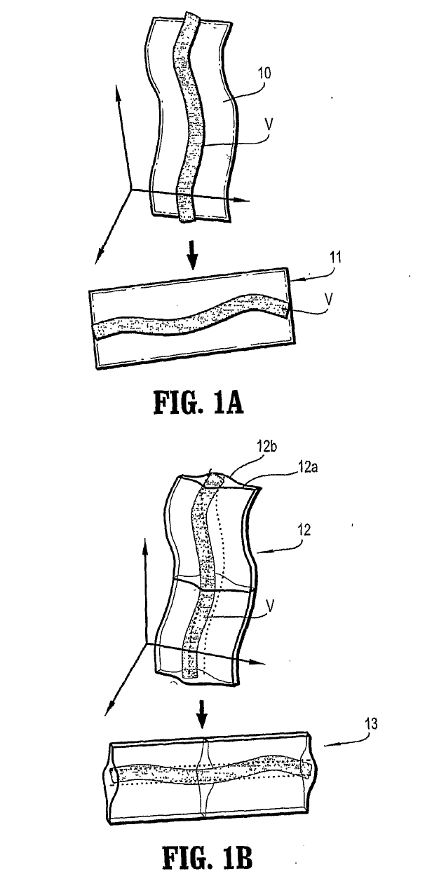

Exemplary embodiments of the invention include systems and methods for providing 3-D visualization of vascular structures using VPR rendering of 3D biconvex slab volumes to render precise 3D spatial information. Vascular visualization methods according to exemplary embodiments of the invention include methods for resampling image data within thick biconvex slab (as opposed to a thin 2D surface as with conventional methods) to enable fast and efficient visualization of an entire vascular volume in one image and minimize the obstructions from adjacent organs, such as bones. FIGS. 1A and 1B are exemplary diagrams that illustrate differences between conventional VPR rending and visualization methods and exemplary methods according to the invention.

In particular, FIG. 1A depicts a conventional vascular visualization process, wherein a vascular structure (V) is visualized by resampling a VCAS (vascular central axis surface) (10), which is a curved surface passing through a vascular central axis (VCA) (vessel centerline) of the vascular structure (V). The VCA of the vessel (V) is located on the curved surface (10). In other words, the VCAS (10) is a curved cross-section that passes through the entire VCA of the vessel (V). A planar transformation is applied to flatten the VCAS (10) to generate a 2D image (11). With the conventional VCAS planar reformation (VPR) method of FIG. 1A, the entire vessel (V) can be flattened on a planar surface and the entire vascular centerline can be displayed on the single image (11). However, as noted above, vascular abnormalities will not appear in the generated image when the scanning surface (VCAS (10)) does not intersect such abnormalities.

FIG. 1B is an exemplary diagram that generally illustrates a vascular visualization method according to an exemplary embodiment of the invention. With the exemplary embodiment of FIG. 1B, the vascular central axis surface is a thick 3D convex hull slab (referred to herein as biconvex slab) (12) which encloses the entire vascular structure (V). As shown, the biconvex slab (12) comprises a first curved surface (12a) and a second curved surface (12b), which enclose the vascular structure (V). By applying 3D volume rendering techniques to the 3D volume enclosed by the biconvex slab (12), a 3D image (13) can be rendered which includes the entire vessel in the one image (13) (as opposed to FIG. 1A wherein only the vascular centerline is rendered in a single 2D image (11).)

In general, a vascular central axis surface (VCAS) can be represented by a ruled surface in mathematics, that is, a surface that can be swept out by a moving line in space, and has a parameterization of the form r(u,v)=a(u)+v\vec{l}(u)), where a(u) is a 3D curve called a directrix or base curve, and \vec{l}(u) is a director vector. The straight lines themselves are called rulings. For curved MPR, a(u) is the vascular central axis (VCA) and \vec{l}(u) is a constant vector, the vector-of-interest (Voi). The Voi is usually chosen to be orthogonal to the main orientation of the VCA.

Thus, the VCAS can be rewritten as VCAS(u,v)=VCA(u)+v\vec{Voi}. The Gaussian curvature of VCAS is everywhere zero, thus a VCAS can be flattened onto a plane. The VCAS is filled by scanning and re-sampling each ruling in the volume data to create a curved MPR. In order to view the entire vessel without overlapping, curved MPR can stretch the VCAS along the main orientation of the VCA (the longitude vector of the image) in different ways, such as stretched MPR, and straightened MPR.

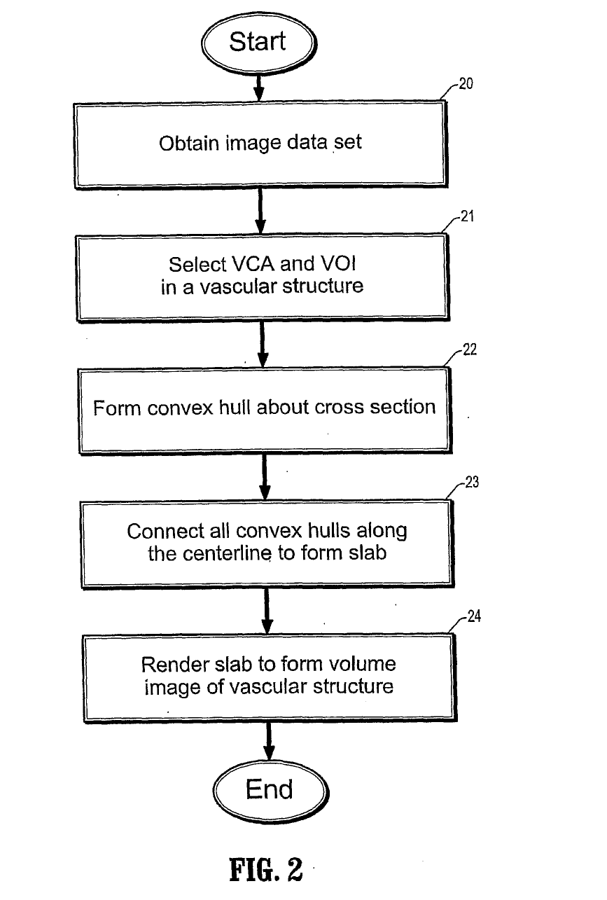

FIG. 2 is a flow diagram illustrating a method for vascular visualization according to an exemplary embodiment of the invention. More specifically, FIG. 2 is a flow diagram illustrating a method for VPR rendering of 3D biconvex slab volumes to enable 3-D visualization of vascular structures, according to an exemplary embodiment of the invention. In general, the exemplary method of FIG. 2 includes an initial step to obtain an image data set including image data of a vascular structure under examination (step 20). The image data is then processed to construct a 3D VCAS (biconvex slab), which is then subjected to volume rendering to view the entire vascular structure. More specifically, to construct a 3D VCAS, the image data set is processed to determine a VCA (vascular central axis) (centerline of the vascular structure of interest) using methods known to those of ordinary skill in the art, and a vector-of-interest (Voi) is selected (step 21). More specifically, for each point of the VCA, a straight line is defined by a Voi, which is a scan line of the VCAS for resampling the volume. To view the vessel in 3D, a hull, referred to herein as the biconvex slab, is created to enclose the entire vessel (step 22).

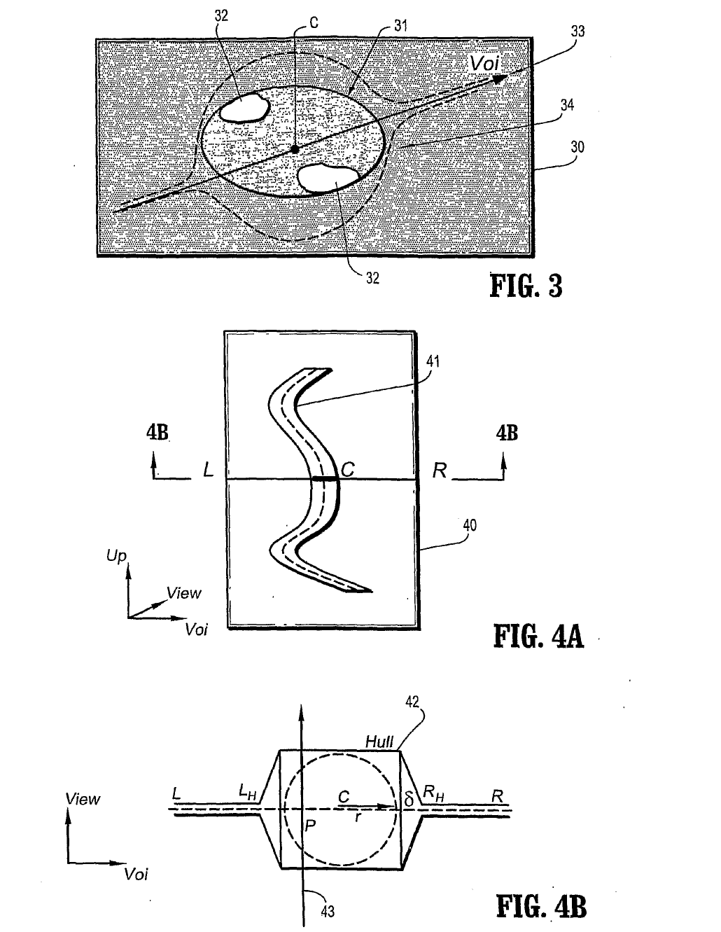

By way of example, FIG. 3 is an exemplary diagram that schematically illustrates the above steps 21 and 22, for example. In particular FIG. 3, is an exemplary 2D image data slice (30) illustrating a vascular structure (31) with calcium deposits (32) in the vessel lumen. FIG. 3 is a cross-sectional view of a portion of the vessel structure (31), which is perpendicular to a center point (C), wherein the center point (C) is a point on the centerline (VCA) of the vessel (31). FIG. 3 further depicts a selected scan line (33) (or VOI). With conventional methods, the resampling results are highly dependent on the orientation of Voi. For example, as depicted in FIG. 3, the scan line (33) misses both calcium deposits (32). FIG. 3 further depicts a convex hull (34) which is determined (in step 22) to enclose the entire vessel (31). The orientation of the convex hull (34) is determined by the scan line (33) Voi.

To fully enclose the vascular structure of interest with a convex hull (step 22), a convex hull is created for each cross-section (2D slice) passing through the center point C (perpendicular to the centerline), using various parameters such as diameter information. To fully specify the convex hull, other geometric information such as maximum diameter at each center point, or, assuming the cross section to be elliptically shaped, the shape parameters of the ellipse, for example are considered.

A biconvex slab is then constructed by connecting all the convex hulls (determined for each cross-section) along the centerline (VCA) (step 23). Thereafter, the biconvex slab can be rendered to obtain a 3D view of the entire vascular structure (step 24). Since the biconvex slab is a 3D volume, volume rendering techniques, including MIP and X-ray rendering methods, can be used to render the 3D view. Since the resulting image of VPR is a flattened plane, in one embodiment of the invention a parallel projection is preferred for biconvex slab rendering.

By way of example, FIGS. 4A and 4B are schematic diagrams that illustrate a method for constructing a convex hull according to an exemplary embodiment of the invention. More specifically, FIGS. 4A and 4B schematically illustrate a method for constructing a biconvex slab that can be rendered using a parallel projection method. As depicted in FIG. 4A, an image space (40) (including a portion of a vessel structure (41) to be examined) can be determined by defining a viewing vector as:
View=Up×Voi,
where Up is a vector perpendicular to Voi, as depicted in FIG. 4A. Moreover, each scan line of a VPR image can be defined by a left point (L), a center point (C), a right point (R), and a maximum radius (r), where:
\vec{CR}=\vec{Voi}, \vec{CL}=−\vec{Voi}, and |LR|=length(Scanline).

Assuming the scan line LR is a thin ribbon, the strip can be rotated 90 degrees along Voi to be viewed on the plane of Voi and View. This rotated strip is depicted in FIG. 4B, where the Up vector now projects out of the plane of the drawing page (i.e., FIG. 4B is a side view of FIG. 4A taken along line LR). The length of the vessel projection on the scan line Voi is less-than or equal to 2r. Assuming that the orientation of the vessel contour is unknown, a hull (42) can be defined as a square-shaped bounding box of size 2r×2r. Considering a margin δ for converting the slab thickness from 2r to a thin ribbon, the scan line LR can be divided into three segments: LL_{H}, L_{H}R_{H}, and R_{H}R, of which LL_{H} and R_{H}R are the scanning range, and L_{H}R_{H} is the rendering range.

In one exemplary embodiment of the invention, for the scanning range, the image is resampled using a normal curved MPR process, assuming a thickness to be 1 voxel. Further, for each pixel P located within the 3D rendering range, a ray (43) can be projected from a point P along the View direction. For a ray (43) of which the distance to C, |CP|, is less than r, the rendering depth of the ray is within ±r: (P−r·View, P+r·View). For rays located in the margin, the depth is interpolated between r and 1, again assuming the minimum thickness to be 1 voxel.

Since VPR can be used to examine the vessel lumen, preferred volume rendering methods include MIP and X-Ray, although other rendering methods can be used and are within the scope of the invention. In accordance with exemplary embodiments of the invention, there are various methods that can be applied to flatten the biconvex slab, including stretching the slab (referred to as curved VPR) and stretching the centerline (referred to as luminal VPR).

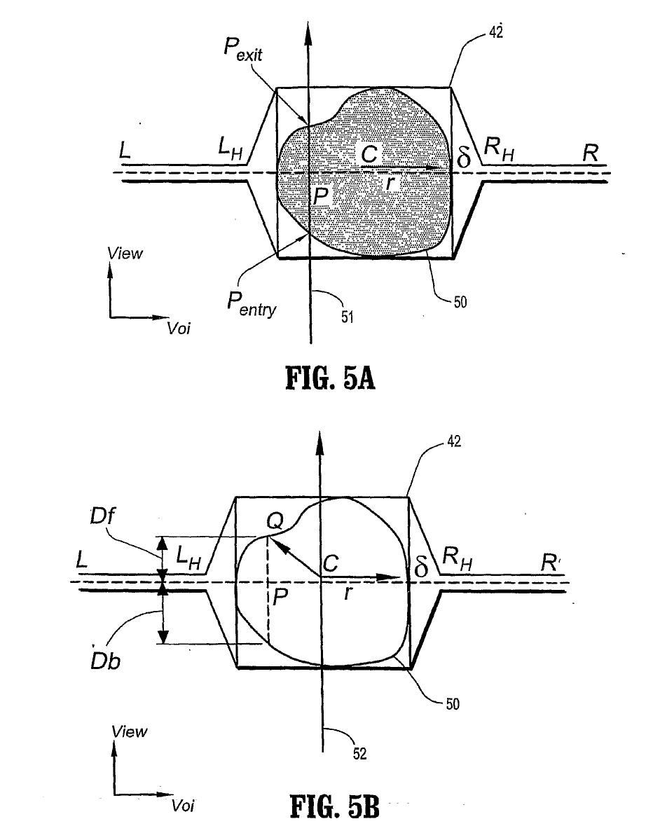

In the exemplary embodiment of FIGS. 4A and 4B, the image space of the biconvex slab is assumed to be a square bounding box (42) that contains image data of the vessel (41). However, a square bounding box is a “loose” convex hull, and contains image data surrounding the vessel boundary, which is not part of the vessel structure. Therefore, in accordance with exemplary embodiments of the invention, the biconvex slab image space can be minimized using methods described hereafter so that that results of volume rendering of the biconvex slab does not include contribution of image data that is outside the vessel structure, but yet included in the loosely defined hull. FIGS. 5A and 5B are diagrams that schematically illustrate methods for minimizing the image space of a biconvex slab according to exemplary embodiments of the invention.

More specifically, FIG. 5A schematically depicts a method for minimizing the biconvex slab image space using volume data, according to an exemplary embodiment of the invention. FIG. 5A depicts a hull (42) having a square-shaped bounding box of size 2r×2r as defined above, containing a slice portion of the volume data of a vascular structure (50). When using volume data, such as data from a vessel segmentation volume, the initial ray (51) estimated by the square bounding box will traverse the segmentation volume (50) to calculate an entry point (P_{entry}) and exit point (Pₑₓᵢₜ). Including a margin δ, the final ray will accumulate the volume contribution within (P_{entry}−δ·View, Pₑₓᵢₜ+δ·View).

Moreover, FIG. 5B schematically depicts a method for minimizing the biconvex slab image space using geometric data according to an exemplary embodiment of the invention. With the exemplary method, geometric data such as contours or the orientations of maximum and minimum diameters, the contour (boundary) of the vessel (50) is projected along the View direction to the scan line (LR). If only the orientations of maximum and minimum diameters are available, a rough ellipse can be estimated. A buffer can be used to the find both the maximum forward and backward depth (\vec{CQ}·\vec{View}) along the scan line. Thus, each pixel on the scan line will have two depths: Df (plus—forward) and Db (minus—backward). Assuming a margin δ, the volume rendering region is (P−(Db+δ)·View, P+(Df+δ)·View).

It is to be understood that the methods described above may be implemented using various forms of hardware, software, firmware, special purpose processors, or a combination thereof. Preferably, the present invention is implemented as a combination of both hardware and software, the software being an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof) which is executed via the operating system. In addition, various other peripheral devices may be connected to the computer platform such as an additional data storage device.

It is to be further understood that since the exemplary systems and methods described herein can be implemented in software, the actual method steps may differ depending upon the manner in which the present invention is programmed. Given the teachings herein, one of ordinary skill in the related art will be able to contemplate these and similar implementations or configurations of the present invention.

Indeed, while the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed is:

1. A method of visualizing a vascular structure, said method comprising the steps of:
providing a digital image of a vascular structure wherein said image comprises a plurality of intensities corresponding to a domain of points in a D-dimensional space;
selecting a vascular central axis and a vector of interest in the image of the vascular structure, and forming a plurality of cross sections perpendicular to said vascular central axis;
forming a convex hull to enclose each cross section, wherein said convex hull is oriented by said vector of interest and determined by the shape of the cross section;
connecting each convex hull to form a biconvex slab; and
rendering said biconvex slab to form an image of said vascular structure.

2. The method of claim 1, wherein said rendering further comprises the steps of:
defining a viewing vector perpendicular to a plane containing the vector of interest and the vascular central axis;
forming a scan line through the vascular structure and along the vector of interest, wherein said scan line includes a left point, a center point, and a right point;
forming a square bounding box about the convex hull, wherein the intersection of each scan line with the bounding box defines a rendering range; and
emitting a ray through each pixel within the rendering range, wherein the rendering depth of the ray is within the maximum radius of the hull.

3. The method of claim 2, wherein said rendering further comprises the steps of:
estimating a ray that passes through the image, wherein said ray estimation is determined by said bounding box;
calculating an entry point and an exit point of the ray through the vascular structure in said image;
including a margin on each side of the bounding box; and
repeating said estimating step and calculating step to accumulate each volume contribution.

4. The method of claim 2, wherein said rendering further the steps of:
forming a contour from each said cross section;
projecting said contour along the viewing vector to the scan line to find a maximum forward depth and a maximum backward depth along the scan line;
including a margin on each side of the bounding box; and
repeating said projecting step to accumulate each volume contribution.

5. The method of claim 2, wherein said rendering further comprises a curved multi-planar reformation of the biconvex slab with rotation.

6. The method of claim 5, wherein the curved multi-planar reformation includes a modified maximum intensity projection.

7. The method of claim 5, wherein the curved multi-planar reformation includes a modified x-ray projection.

8. The method of claim 5, wherein the curved multi-planar reformation includes an adjustable diameter slab maximum intensity projection.

9. The method of claim 2, wherein said rendering further comprises a luminal multi-planar reformation on the biconvex slab with rotation.

10. The method of claim 2, wherein said rendering further comprises a luminal curved-planar reformation on the biconvex slab with rotation.

11. The method of claim 1, further comprising displaying in three-dimensional a double-oblique cross-sectional slab location.

12. The method of claim 1, further comprising the step of interactively rotating said image of said vascular structure in order to determine a viewing vector.

13. The method of claim 1, further comprising the step of interactively zooming-in or zooming-out said image of said vascular structure.

14. A method of visualizing a vascular structure, said method comprising the steps of:
providing a digital image of a vascular structure wherein said image comprises a plurality of intensities corresponding to a domain of points in a D-dimensional space;
selecting a vascular central axis and a vector of interest in the image of the vascular structure, and forming a plurality of cross sections perpendicular to said vascular central axis;
forming a convex hull to enclose each cross section, wherein said convex hull is oriented by said vector of interest and determined by the shape of the cross section;
connecting each convex hull to form a biconvex slab;
defining a viewing vector perpendicular to a plane containing the vector of interest and the vascular central axis;
forming a scan line through the vascular structure and along the vector of interest, wherein said scan line includes a left point, a center point, and a right point;
forming a square bounding box about the convex hull, wherein the intersection of each scan line with the bounding box defines a rendering range; and
emitting a ray through each pixel within the rendering range, wherein the rendering depth of the ray is within the maximum radius of the hull.

15. The method of claim 14, further comprising the steps of:
estimating a ray that passes through the image, wherein said ray estimation is determined by said bounding box;
calculating an entry point and an exit point of the ray through the vascular structure in said image;
including a margin on each side of the bounding box; and
repeating said estimating step and calculating step to accumulate each volume contribution.

16. The method of claim 14, further comprising the steps of:
forming a contour from each said cross section;
projecting said contour along the viewing vector to the scan line to find a maximum forward depth and a maximum backward depth along the scan line;
including a margin on each side of the bounding box; and
repeating said projecting step to accumulate each volume contribution.

17. A program storage device readable by a computer, tangibly embodying a program of instructions executable by the computer to perform the method steps for visualizing a vascular structure, said method comprising the steps of:
providing a digital image of a vascular structure wherein said image comprises a plurality of intensities corresponding to a domain of points in a D-dimensional space;
selecting a vascular central axis and a vector of interest in the image of the vascular structure, and forming a plurality of cross sections perpendicular to said vascular central axis;
forming a convex hull to enclose each cross section, wherein said convex hull is oriented by said vector of interest and determined by the shape of the cross section;
connecting each convex hull to form a biconvex slab; and
rendering said biconvex slab to form an image of said vascular structure.

18. The computer readable program storage device of claim 17, wherein said rendering further comprises the steps of:
defining a viewing vector perpendicular to a plane containing the vector of interest and the vascular central axis;
forming a scan line through the vascular structure and along the vector of interest, wherein said scan line includes a left point, a center point, and a right point;
forming a square bounding box about the convex hull, wherein the intersection of each scan line with the bounding box defines a rendering range; and
emitting a ray through each pixel within the rendering range, wherein the rendering depth of the ray is within the maximum radius of the hull.

19. The computer readable program storage device of claim 18, wherein said rendering further comprises the steps of:
estimating a ray that passes through the image, wherein said ray estimation is determined by said bounding box;
calculating an entry point and an exit point of the ray through the vascular structure in said image;
including a margin on each side of the bounding box; and
repeating said estimating step and calculating step to accumulate each volume contribution.

20. The computer readable program storage device of claim 18, wherein said rendering further comprises the steps of:
forming a contour from each said cross section;
projecting said contour along the viewing vector to the scan line to find a maximum forward depth and a maximum backward depth along the scan line;
including a margin on each side of the bounding box; and
repeating said projecting step to accumulate each volume contribution.

21. The computer readable program storage device of claim 18, wherein said rendering further comprises a curved multi-planar reformation of the biconvex slab with rotation.

22. The computer readable program storage device of claim 21, wherein the curved multi-planar reformation includes a modified maximum intensity projection.

23. The computer readable program storage device of claim 21, wherein the curved multi-planar reformation includes a modified x-ray projection.

24. The computer readable program storage device of claim 21, wherein the curved multi-planar reformation includes an adjustable diameter slab maximum intensity projection.

25. The computer readable program storage device of claim 18, wherein said rendering further comprises a luminal multi-planar reformation on the biconvex slab with rotation.

26. The computer readable program storage device of claim 18, wherein said rendering further comprises a luminal curved-planar reformation on the biconvex slab with rotation.

27. The computer readable program storage device of claim 17, the method further comprising displaying in three-dimensional a double-oblique cross-sectional slab location.

28. The computer readable program storage device of claim 17, the method further comprising the step of interactively rotating said image of said vascular structure in order to determine a viewing vector.

29. The computer readable program storage device of claim 17, the method further comprising the step of interactively zooming-in or zooming-out said image of said vascular structure.
